(19) United States
(12) Patent Application Publication
(10) Pub. No.: US 2009/0188076 A1
(43) Pub. Date: Jul. 30, 2009

(54) Block for Window Block and Tackle Sash Balance

(75) Inventor: Richard S. deNormand, Victor, NY (US)

Correspondence Address: BROWN & MICHAELS, PC;400 M & T BANK BUILDING, 118 NORTH TIOGA ST, ITHACA, NY, 14850, US

(73) Assignee: CALDWELL MANUFACTURING COMPANY, Rochester, NY (US)

(21) Appl. No.: 12/021,617

(22) Filed: Jan. 29, 2008

(51) Int. Cl. E05D 13/00

(52) U.S. Cl. 16/211

(57) ABSTRACT

A block shaped to fit onto an end of a block and tackle window balance containment tube which controls excessive airflow into and out of the jamb channel of the window frame to assist with the insulating function of the window frame and to substantially prohibit the accumulation of dirt and dust within the balance containment tube. The block is secured to the end of the balance containment tube by a rigid or semi-rigid retainer. The block itself may consist of either a pliable or rigid material.

### FIELD OF THE INVENTION

The invention pertains to the field of block and tackle sash balances. More particularly, the invention pertains to a block inserted into one end of the block and tackle balance to substantially limit air flow through the jamb channel and the accumulation of dirt within the containment tube of the balance.

### BACKGROUND OF THE INVENTION

Windows and particularly double hung window, i.e., those having two vertically movable sashes, utilize a balance mechanism that is contained within the jamb channel of the window frame to assist with the vertical movement of the sashes. One conventional type of balance is referred to as a block and tackle balance because it uses a combination of a cord, springs and pulleys to provide the progressive tension required to assist with the movement of the sash. A certain amount of air leakage is permitted through, and often designed into, the jamb channel by the weather stripping. The amount of air flow, though, may eventually exceed original design parameters and become detrimental to providing an adequately insulated window.

This problem is particularly critical in windows that use block and tackle balances because the open end of the elongated balance channel must provide enough clearance to permit the cord to traverse freely in and out of the end of the channel as the sash is vertically moved. Moisture, sound and foreign matter, such as fine dirt and dust may enter, which would adversely affect the function of the balance. Certain designs have been attempted to address this problem. In particular, U.S. Pat. No. 4,300,316 provides a “foot seal” that is secured to one end of the balance. This foot seal moves up and down the jamb channel as the sash is moved. U.S. Pat. No. 4,642,845 discloses the use of end caps that close off both ends of the balance tube. These end caps are designed to act as seals for pressurized gas contained within a piston and cylinder balance. One of the key drawbacks to this design is that the entire device must be assembled by the balance manufacturer and should one of the end caps fracture, the seal is compromised causing the balance to fail, necessitating replacement of the entire balance. The replacement of a defective or worn out balance is a costly and destructive process, often requiring replacement of a sizeable portion of the window assembly, especially around the jamb channel. An effective yet inexpensive end seal or block is needed that can be assembled by either the balance manufacturer or the window manufacture after construction of the window assembly.

### SUMMARY OF THE INVENTION

The present invention consists of a block shaped to fit onto an end of the balance containment tube of a conventional window block and tackle balance. Its purpose is to prevent excessive airflow into and out of the carrier channel of a window frame to control the insulating function of the window frame and to substantially prohibit the accumulation of dirt and dust within the balance containment tube. The block is secured to the end of the balance containment tube by a rigid or semi-rigid retainer.

### DRAWINGS

FIG. 1 shows an exploded view of a conventional block and tackle balance having the air flow block and the retainer separated from the balance.

FIG. 2 shows the block and tackle balance of FIG. 1 with all parts connected as designed.

FIG. 3 shows the assembled block and tackle balance of FIG. 2 sectioned at the end where the cord extends to secure to a retaining clip in order to show how the block is secured to the balance.

FIG. 4 shows an exploded view of a conventional block and tackle balance within a jamb channel of a window frame with the air flow block and the retainer separated from the balance.

FIG. 5 shows the block and tackle balance of FIG. 4 within the jamb channel having the air flow block and retainer secured to the end of the balance containment tube and the retaining clip engaged with the end of a wall of the jamb channel.

### DETAILED DESCRIPTION

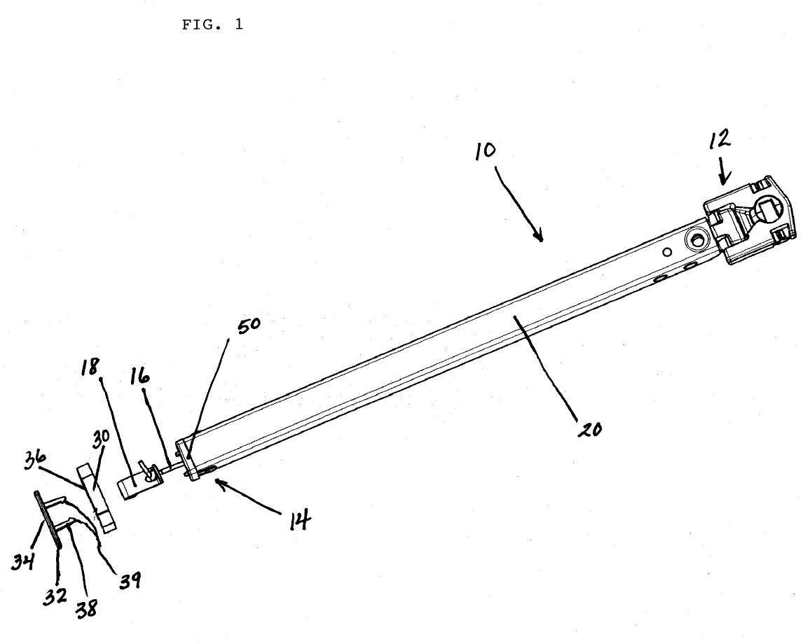

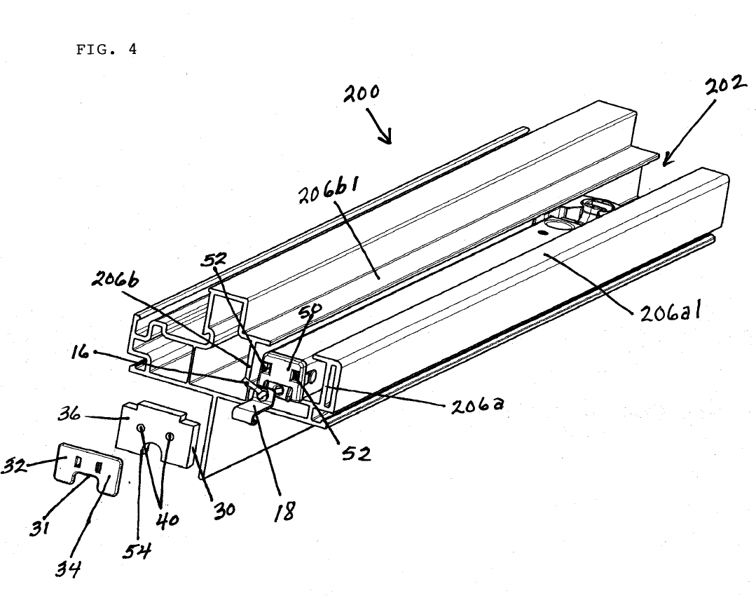

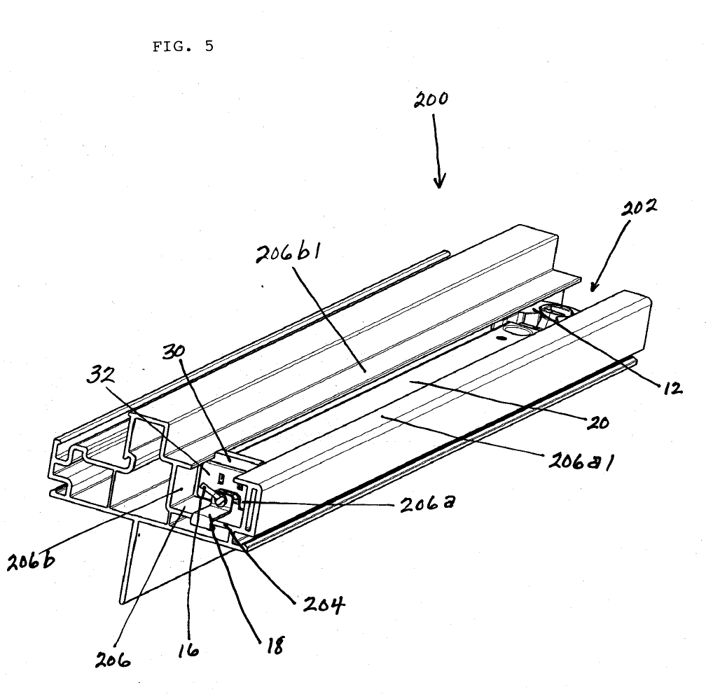

Referring to FIG. 1, a conventional block and tackle window balance 10 is shown with a block 30 of the present invention. The first end 12 of the block and tackle balance 10 attaches to the sash of a window (not shown) and rides up and down the jamb, or carrier, channel 202 of a window frame 200 (please refer to FIGS. 4 and 5). The internal mechanism of a block and tackle balance consist of a cord 16 and a series of pulleys and springs (not shown) within the balance containment tube 20 that provide tension to facilitate the movement of a window sash vertically through a jamb channel 202.

The free end of the cord 16 extends out the second end 14 of the block and tackle balance 10 and is secured to a retaining hook 18. The purpose of the retaining hook 18 is to engage an end wall 204 (see FIG. 5) of the jamb channel 202. In operation of the window assembly, when the sash is vertically moved up or down the jamb channel 202, the entire block and tackle balance 10 moves along with the sash. Since the retaining hook 18 is fixed in position with the end wall 204 of the jamb channel 202, the cord 16 (the end of which remains attached to the retaining hook 18), progressively extends out of the second end 14 of the containment tube 20. As the cord 16 continues to extend, increasing tension is exerted on the sash by the pulleys and spring system of the block and tackle balance 10 to assist with either the raising or lowering of the sash.

The movement of any balance through a jamb channel can accommodate a certain amount of air exchange that complies with original design parameters. However, excessive wearing of certain components, especially a weather seal, over time results in an unacceptable amount of air exchange between the inside and outside of a building or house. The present invention is a system consisting of a device that provides the dual function of maintaining an acceptable level of air flow through the jamb channel 202 while substantially prohibiting the accumulation of dirt and dust within the containment tube 20 of the block and tackle balance 10. Dust and dirt will eventually compromise the proper function of the pulley and cord system, thus adversely affecting the proper tension requirement and mobility of the sash.

The present invention substantially alleviates these problems by providing an air flow stop in the form of a block 30, which is secured to the second end 14 of a block and tackle balance 10. Optional means may be used to secure the block 30 to the second end 14 of the balance 10, such as by means of an adhesive, but the preferable method is by use of a substantially rigid retainer 32. The retainer 32 consist of a plate portion 34 which abuts the outer surface 36 of block 30. In one embodiment, at least one projection 38, is integrally formed with the retainer 32, and traverses through corresponding holes 40 (see FIG. 4) in block 30. An alternate embodiment would have the at least one projection 38 connect to an end cap 50, located at the second end of the containment tube 20, or the projection 38 may be attached to or originate from the containment tube 20 itself.

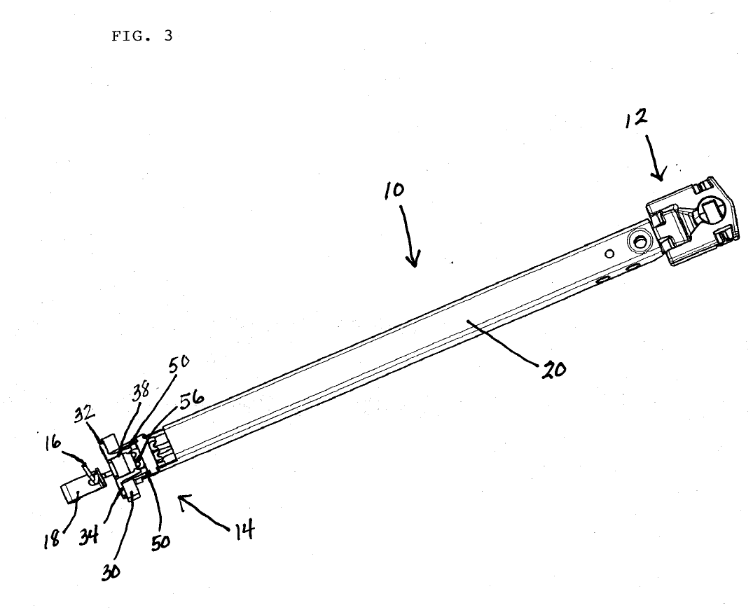

In the first embodiment, as exemplified by the appended Figures, the end cap 50, has retaining holes 52 that correspond to the at least one projection 38 and the holes 40 in the block 30 (see FIGS. 3 and 4). To assemble the block 30 to the block and tackle balance 10, the block 30 is urged into abutment with the end cap 50. Note that a cut out 54 is provided on an edge of the block 30 to accommodate the cord 16. Depending on the design of the block and tackle balance 10 and the location of the cord 16 and pulleys (not shown), the cut out 54 may be along any edge of the block 30, so long as it corresponds to the location of the cord 16 in order not to interfere with the function of cord 16. In the view shown in FIG. 4, this cut out 54 is adjacent the transverse wall 206 of jamb channel 202. Note that the retainer 32 also has a corresponding cut out 31 to accommodate and not interfere with the function of retaining hook 18.

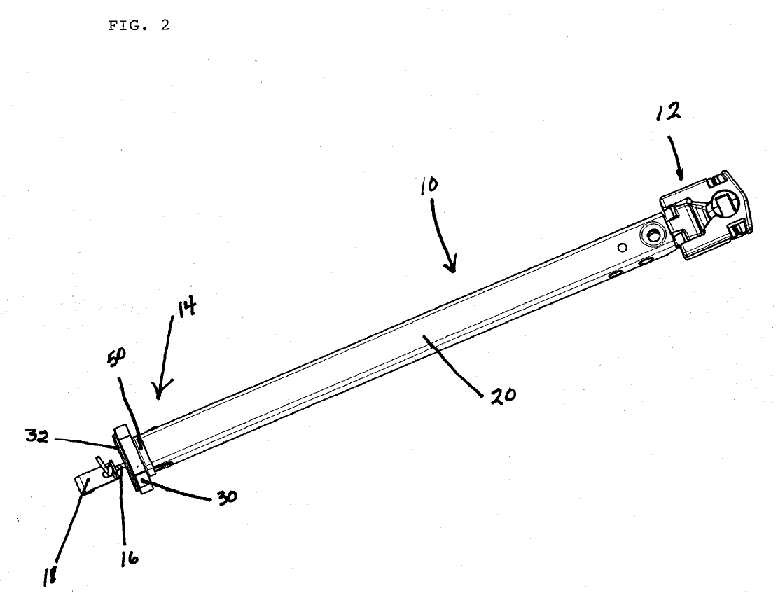

Once the block 30 is in abutment with end cap 50, projections 38 are inserted through corresponding holes 40 in block 30 continuing through retaining holes 52 in end cap 50. Tab hooks 39 at the ends of each projection 38 securely snap into place inside mating retaining ledges on the inner surface 56 of end cap 50. FIG. 2 shows the block 30 of the present invention assembled on the block and tackle balance 10.

As best shown in FIGS. 4 and 5, the perimeter shape of the block 30 corresponds to the cross sectional shape of the jamb channel 202, which consist of transverse wall 206, opposing side walls 206a and 206b, plus corresponding opposing wall ledges 206a1, and 206b1, respectively.

Block 30 may be made from a pliable material that enables it to travel through jamb channel 202 with substantially minimal resistance during the vertical movement of the sash through the jamb channel 202. Such material may consist of a synthetic foam material, having either open or closed cells. It may also consist of various rubber or other polymers, such as any of a variety of acrylics, nitrites, EPDM, and the like. Block 30 may also consist of a rigid or semi-rigid material, such as a metal, any variety of metal alloy or a hardened synthetic resin.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A combination of an air flow stop and a block and tackle sash balance arranged in a jamb channel of a window, the combination comprising:
a block shaped to fit the cross sectional contour of the jamb channel to form an air flow stop;
a retainer holding the block in a position adjacent to an end region of the balance from which a cord from the block and tackle emerges, the end region containing an end cap; and
the retainer being connected to the cap of the end region of the block and tackle balance; and
wherein the block is in position between the retainer and the end cap to substantially limit air flow within the jamb channel.

2. The combination of claim 1 wherein the retainer has at least one projection.

3. The combination of claim 2 wherein each of the at least one projection extends through a corresponding hole in the block and a corresponding latching hole in the end cap.

4. The combination of claim 3 wherein the each projection snaps securely over a ledge on the interior surface of the end cap.

5. The combination of claim 1 wherein the block consists of a pliable material.

6. The combination of claim 1 wherein the block consists of a rigid or semi-rigid material.

7. An air flow block disposed within a jamb channel of a window occupied by a block and tackle balance, the air flow block comprising:
a block disposed at an end of the balance where a cord from the block and tackle balance extends from an end of a containment tube of the block and tackle balance, the block having at least one hole for receiving a projection therethrough;
a retainer to secure the block in an operating position at the end of the balance;
the retainer being connected to an end cap of the balance to hold the block in place, the end cap being secured to the end of the containment tube of the balance.

8. The air flow block of claim 7 wherein each projection has a tab hook at its end.

9. The air flow block of claim 8 wherein the end cap has at least one projection that corresponds to the hole in the block and traverses through a corresponding hole in the block and secures to the retainer through a corresponding hole in the retainer.

10. The air flow block of claim 8 wherein at least one projection is connected to the jamb channel and projects through a corresponding hole in the block and secures to the retainer through a corresponding hole in the retainer.

11. The air flow block of claim 8 wherein at least one projection is connected to the retainer and traverses through a corresponding hole in the block and secures to the end cap through a corresponding hole in the end cap.

12. The air flow block of claim 7 wherein the block is dimensioned so that when held in place by the retainer, the block substantially limits excessive air flow in the jamb channel.

13. The air flow block of claim 7 wherein the block conforms to a cross section of the jamb channel into which the block and tackle balance is installed.

14. A system for substantially limiting air flow in a window jamb channel containing a block and tackle balance, the system comprising:
a block dimensioned to limit air flow in the jamb channel;
a retainer arranged to hold the block in a mounted position within the channel; and
an end cap positioned at a cord end of the balance in abutment with the block.

15. The system of claim 14 wherein the retainer has at least one projection that traverses through a hole in the block, the projection having a tab hook at its end, the projection continuing to traverse through a corresponding hole in the end cap, the tab hook securing the retainer and block to the end cap.

16. The system of claim 14 wherein the end cap has at least one projection that corresponds to and traverses through the hole in the block and secures to the retainer through a corresponding hole in the retainer.

17. The system of claim 14 wherein at least one projection is connected to the jamb channel and projects through a corresponding hole in the block and secures to the retainer through a corresponding hole in the retainer.
